(19) United States
(12) Patent Application Publication
(10) Pub. No.: US 2018/0262059 A1
(43) Pub. Date: Sep. 13, 2018

(54) ELECTRIC VEHICLE CHARGING VIA RF LOOPS TO AVOID NEED FOR PRECISE ALIGNMENT WITH WIRELESS CHARGING EQUIPMENT

(71) Applicant: AMI Research & Development, LLC, Windham, NH (US)

(72) Inventors: John T. Apostolos, Lyndeborough, NH (US); William Mouyos, Windham, NH (US)

(21) Appl. No.: 15/887,066

(22) Filed: Feb. 2, 2018

Related U.S. Application Data
(60) Provisional application No. 62/454,308, filed on Feb. 3, 2017.

(51) Int. Cl. H02J 50/20; H02J 7/02; B60L 11/18; H01Q 7/00

(52) U.S. Cl. CPC H02J 50/20; H01Q 7/00; B60L 11/1809; H02J 7/025

(57) ABSTRACT

A loop antenna in an electric vehicle receives energy wirelessly from a source external to the vehicle, such as from a Radio Frequency (RF) emitter. The use of RF loop antennas to both transmit and receive power greatly reduces the need to align the vehicle with charging station equipment.

### CROSS REFERENCE TO RELATED APPLICATIONS

This application claims priority to a co-pending U.S. Provisional Patent Application Ser. No. 62/454308 filed Feb. 3, 2017 entitled “ELECTRIC VEHICLE CHARGING VIA RF LOOPS TO AVOID NEED FOR PRECISE ALIGNMENT WITH A WIRELESS CHARGING EQUIPMENT”, the entire contents of which are hereby incorporated by reference.

### BACKGROUND

### Technical Field

This patent application relates to electric vehicle charging.

### SUMMARY

A single turn, wire loop antenna in an electric vehicle receives energy wirelessly from a charging station source external to the vehicle, such as from a Radio Frequency (RF) emitter. The RF emitter may transmit energy also using a single turn, wire loop antenna that is somewhat smaller in diameter than the loop antenna in the vehicle. The use of RF loop antennas to both transmit and receive power greatly reduces the need to precisely align the vehicle with a charging station. The arrangement thus has distinct advantages over conventional inductive charging systems that use inductive coils.

### BRIEF DESCRIPTION OF THE DRAWINGS

The description below refers to the accompanying drawings, of which:

FIG. 1 illustrates using single turn loop antennas to transmit energy from a charging station to be received by an electric vehicle;

FIG. 2 is a more detailed view of the single turn loop antennas, a Voltage Standing Wave Ratio (VSWR) adjustment circuit on the transmit side, and an automatic antenna tuning circuit on the receive side;

FIG. 3 is an another arrangement that detects an obstruction and shuts down the transmitter in the charging station;

FIG. 4 is an implementation that reduces the effect of ambient radiation leaking into the passenger compartment;

FIG. 5 is a crossed dipole addition to the receiving antenna that improves performance in a power scavenging mode; and

FIG. 6 is a plot of expected transfer efficiency versus offset spacing between the two loops.

### DETAILED DESCRIPTION OF AN EMBODIMENT

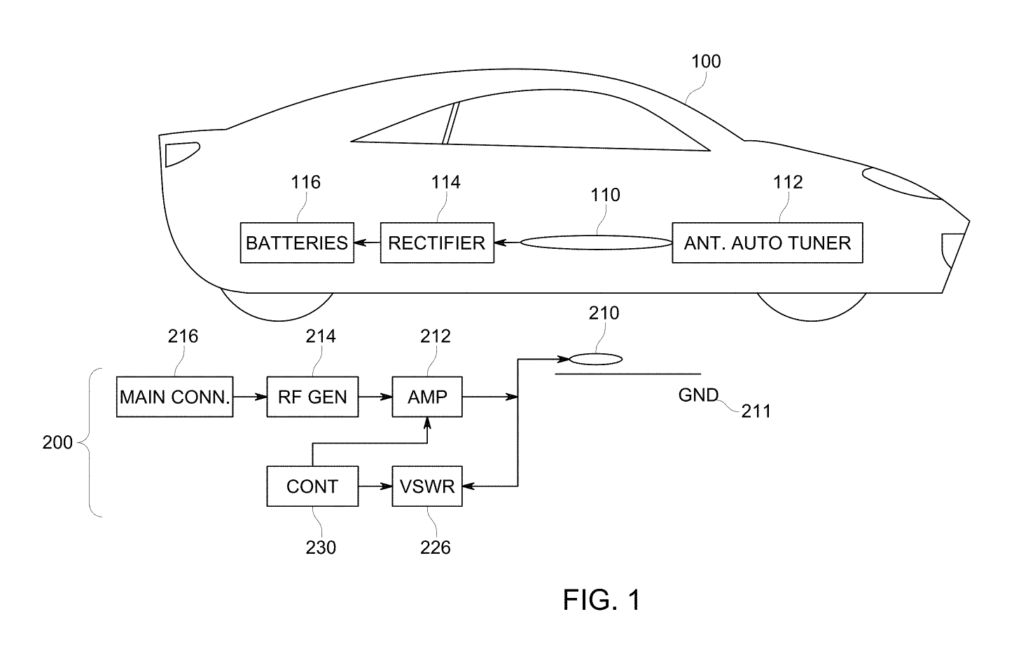

As shown in FIG. 1, an electric vehicle 100 includes a generally circular, single turn, wire loop antenna 110, an automatic antenna tuner 112, a rectifier 114, and energy storage device such as one or more batteries 116. Charging station 200 includes another, smaller, single turn, wire loop antenna 210 typically placed over a ground plane 211 beneath the vehicle 100. Charging station 200 also includes a Radio Frequency (RF) amplifier 212, an RF signal generator 214, and a connection 216 to a power source such as a connection to main line Alternating Current (AC) connection.

In one implementation, vehicle loop antenna 100 may be a 0.25 inch metal pipe approximately 3 feet in diameter. The vehicle loop antenna 110 may be parasitically fed power from the charging antenna 210.

The charging loop antenna 210 may have a somewhat smaller diameter than the vehicle loop antenna 110, such as between 0.5 and 1 foot. In preferred embodiments, the charging loop antenna is at least three times smaller than the vehicle antenna 210. Having the parasitically fed vehicle antenna 210 somewhat larger in diameter than the charging antenna 110 reduced the need for critical alignment between the charging station 200 and the vehicle 100.

The charging antenna 210 may be actively fed from the amplifier 212 such as via a microstrip connection.

In one embodiment, energy is transferred from the charging loop antenna 210 to the vehicle loop antenna 110 at a radio frequency near 50 MHz; this may preferably be within one of the unlicensed radio bands in the 49 MHz range. However, operation at other radio frequencies is possible.

For RF transmission in or near 50 MHz, one expects a transmit antenna 210 with such small dimensions (between 0.5 and 1 foot) to be a relatively inefficient radiator; therefore its signal strength in the far field (more than a couple of feet away) would be significantly reduced. However, one potential advantage of this arrangement is that a floor or other components of the vehicle 100 above the vehicle loop antenna 110, if formed of primarily metal or other conductive surfaces, will naturally act as a radio frequency shield. The vehicle 100 itself can thus also serve to attenuate the radio frequency energy emitting from charging antenna 210 from leaking into the surrounding area.

The metallic floor of the vehicle, closely spaced to the receiving loop 110 also acts a ground plane and thus as an RF mirror to reflect energy in the 49-50 MHz frequency range. This mirror image acts to further increase efficiency.

In many implementations, it is desirable to reduce the amount of power reflected back into the transmitter amplifier 212, in other words, to minimize the Voltage Standing Wave Ratio (VSWR). However the VSWR will be different for different positions of the charging loop 210 and vehicle loop 110 with respect to one another. Thus a VSWR meter 226 may be placed on the transmit side to detect RF energy reflected back from the charging loop 210. The VSWR meter 226 output feeds a controller 230 that then controls some attribute of the amplifier 212, such as its output impedance. Any known analog or digital control techniques may be utilized for this feedback control of the transmit VSWR.

Automatic tuner 112 on the vehicle side may use any known analog or digital techniques for controlling an adjustable impedance disposed in or adjacent to vehicle loop antenna 110. The automatic antenna tuner 112 further permits the position of the charging station loop antenna 210 to be somewhat independent of the exact position of the vehicle 100. The automatic receive tuner 112 thus eliminates what might otherwise be a cumbersome, difficult to achieve, highly accurate positioning required of charging systems that use multiple turn inductive coils. Such inductive coils used in prior systems must be congruently aligned with one another to operate properly.

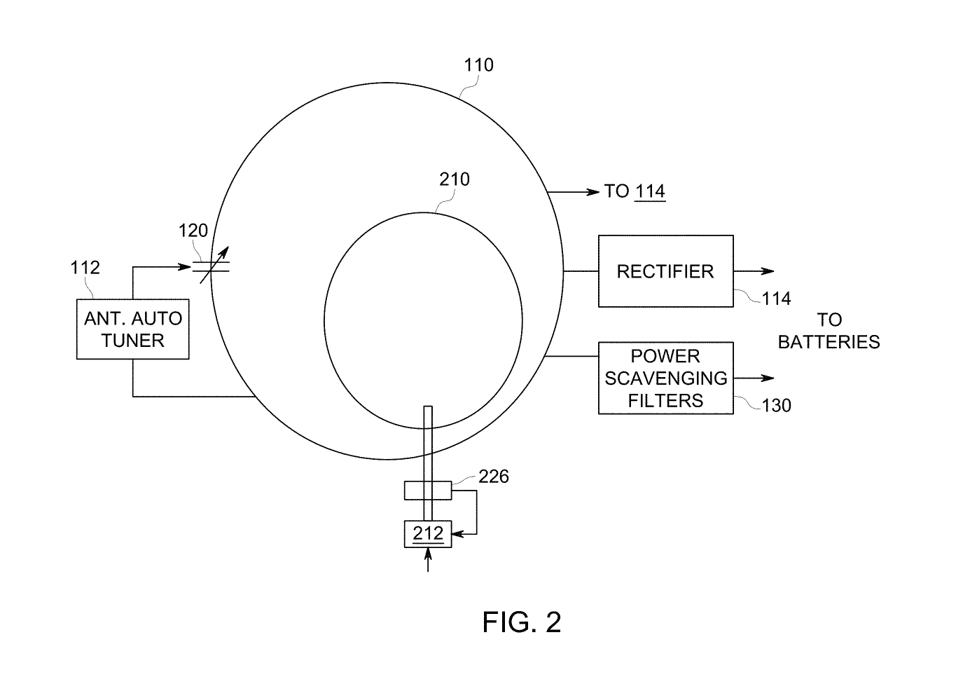

FIG. 2 is a view taken from above of the antennas 110 and 210 where the vehicle 100 and charging station 200 are not perfectly aligned. An adjustable impedance 120 is placed in or adjacent a portion of vehicle antenna 110. The automatic tuner 112 may use a directional coupler or some other incident radio frequency energy detector to determine a detected power level, and then change the impedance presented by the adjustable impedance 120 until energy received is maximized. Additional components (not shown) such as RF filters and/or frequency tuners may also be used on the charging side 200 and vehicle side 100.

FIG. 2 also shows the VSWR meter 226 controlling the transmit circuitry 212.

Charging station loop 210 is thus completely enclosed by vehicle loop 110 and thus aligned even when the two loops 110, 120 are offset by 18 inches or even more. However, it is expected that energy may even be transferred when the vehicle loop 110 merely overlaps and does not completely encompass charging station loop 210.

The charging station 200 components may be packaged in a number of different ways. They may, for example, be installed in the floor of residential garage or a space in which electric vehicles 100 are often parked. Components of charging station 200 may also be placed within a portable container such as a flexible rubber mat. The portable mat can then be roll out on the ground in a location where a connection 216 to an AC power source is available. The charging station 200 components may also be installed within pavement near a stop light, stop sign, or along other road sections to permit the vehicle to be charged while it is in use.

In some implementations it is envisioned that the same vehicle loop antenna 110 may also serve to receive broadcast signals and connect those to other components such as FM radio (not shown in the drawings.)

There may be some concern with transmission of RF power at sufficient levels to charge the batteries 116 in a reasonable time. One particular popular model of electronic vehicle is the Tesla Model X. The standard lithium-ion battery packs in that vehicle have a 60 kWh capacity to produce a range of 232 miles. If the amount of power transmitted between the single turn wire loops 210 and 110 is at least a kilowatt for 10 hours this would provide approximately 1/6 the storage capacity of a Tesla X's battery, resulting in a range of 30.7 miles. If the arrangement can be designed to transfer 6 kW in the same 10 hour period, the batteries 116 would then be fully charged.

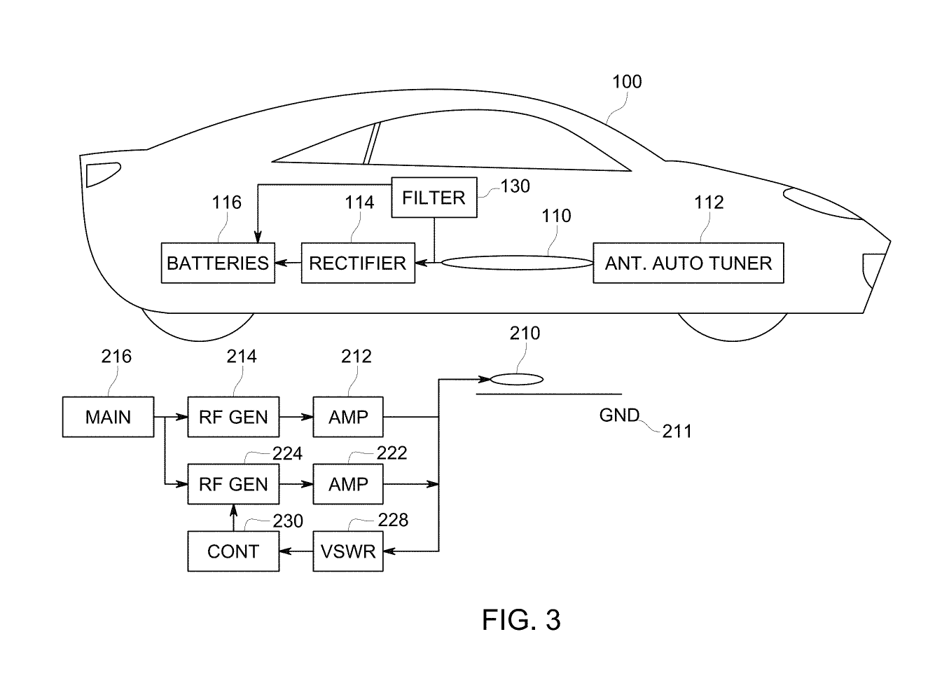

In certain environments a domestic pet, small wild animal, child, or other object may possibly walk or otherwise end up between wire loops 110 and 210. Additional circuitry can detect these condition(s) and safely shut down the charging station 200, as shown in FIG. 3. Here a separately transmitted radio signal at a different frequency and potentially much lower power may be generated by a second RF generator 224 and second amplifier 222 and coupled into the same transmit antenna 210. A detector such as a Voltage Standing Wave Ratio (VSWR) meter 228 (which may be the same or different VSWR meter than meter 226 mentioned above) may then may also be coupled to the transmit loop 210 to detect variations in energy transmitted at the second frequency. When such variations are detected, it may be concluded that these variations are caused by the presence of a small animal or other undesired object which has come between loop antennas 110 and 210. In this instance the controller 230 may cause RF generator 214 to shut down or reduce its transmitted RF power 214. At the same time, the controller may sound an alarm, activate a visual indicator, send a text message or activate an application on a mobile phone of the operator of the vehicle, or initiate some other indication that obstruction exists within the charging equipment 200. When the detector 226 indicates the disturbance is removed, and/or the operator indicates a safe condition again exists, the controller 230 may then again operate the RF generator 214 as normal.

It is possible to use other techniques for detecting the presence of an object necessitating shut down of the transmitter. For example, an infrared camera operating at, say, a 4 micron wavelength, may be used to detect biological objects. An acoustic sensor may also detect the presence of objects.

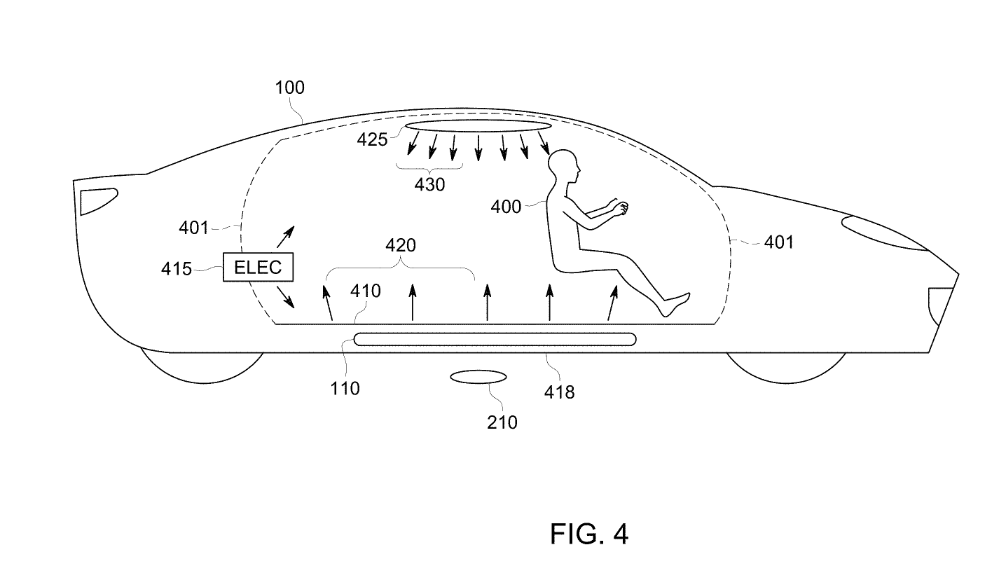

In some cases it may be desirable for a human vehicle operator to safely remain in the vehicle during a wireless charging operation. FIG. 4 illustrates this situation where a human 400 is sitting in the passenger compartment 401. As per the prior figures, the charging loop antenna 210 feeds power to the vehicle antenna 110. A radiation transparent surface 418 (such as plastic or fiberglass) protects the vehicle antenna 110 from the elements, and a floor 410 portion of the chassis, if metallic, prevents most of the radiation from the charging antenna 210 from reaching the passenger compartment 401. However in some instances, at least some radiation may leak into passenger compartment 401 creating a field 420. The field 420 may be undesirable. In that instance, a field cancellation antenna 425 coupled to further electronics 415 is placed in the passenger compartment 401. The cancellation antenna 425 may be controlled by the electronics 415 to generate a cancellation field 430 that is opposite and complimentary in phase to a field 420 that leaks in to compartment 401. Thus the passenger exposure to field 420 is reduced. The cancellation antenna 425 may be placed in a position such as near the roof, opposite the vehicle power receive antenna 110 in the floor. Although the field 420 may be static, and thus cancellation antenna 425 and electronics 415 fixed in design, the electronics may also detect such fields 420 and adapt the generated cancellation field 430 accordingly.

A parasitic power scavenging mode may also be implemented. Here, the same single turn loop 110 used for receiving wireless power from the charging station may be coupled to one or more RF filters 130 and thus resonated by ambient RF energy to charge batteries 116 while the vehicle 100 does not otherwise have access to a charging station 210. This may enable the vehicle itself to act as an antenna in a parasitic power scavaging mode. An effective area of 10 m² at Ultra High Frequencies (UHF) can be estimated. In that scenario, at a distance of approximate half mile from a high-power UHF television station, the incident field might be about 4 w/m² thus enabling a power scavaging charge rate of 40 W. In this mode, it may be preferable for the filter(s) 130 to tune to a relatively narrow frequency band (such as the bandwidth of the broadcast signal) and/or include acquisition circuitry (not shown) that can scan a range of frequencies and tune the filter(s) 130 to a frequency with a strong ambient received signal strength.

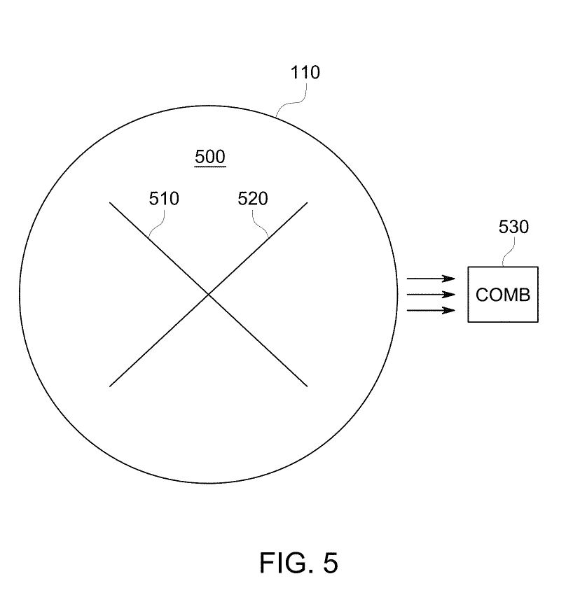

FIG. 5 shows a possible augmentation to the vehicle antenna 110. Here an additional structure, such as one or more pairs of crossed dipole elements 510, 520 may be disposed within the circular wire loop 110. The single turn loop 110 and dipoles 510, 520 may then feed combining circuits 530 to provide polarization and orientation-independent (ORIAN) reception of energy. See U.S. Pat. No. 8,988,303, U.S. Pat. No. 9,013,360, and/or or pending U.S. patent application Ser. No. 15/362,988 filed Nov. 29, 2016 entitled “Super Directive Array of Volumetric Antenna Elements for Wireless Device Applications”, and U.S. patent application Ser. No. 15/627,779 filed Jun. 20, 2017 entitled “Low frequency rectenna system for wireless charging” (all of which are hereby incorporated by reference herein) for further examples of the use of OMAN antennas and the combining circuits.

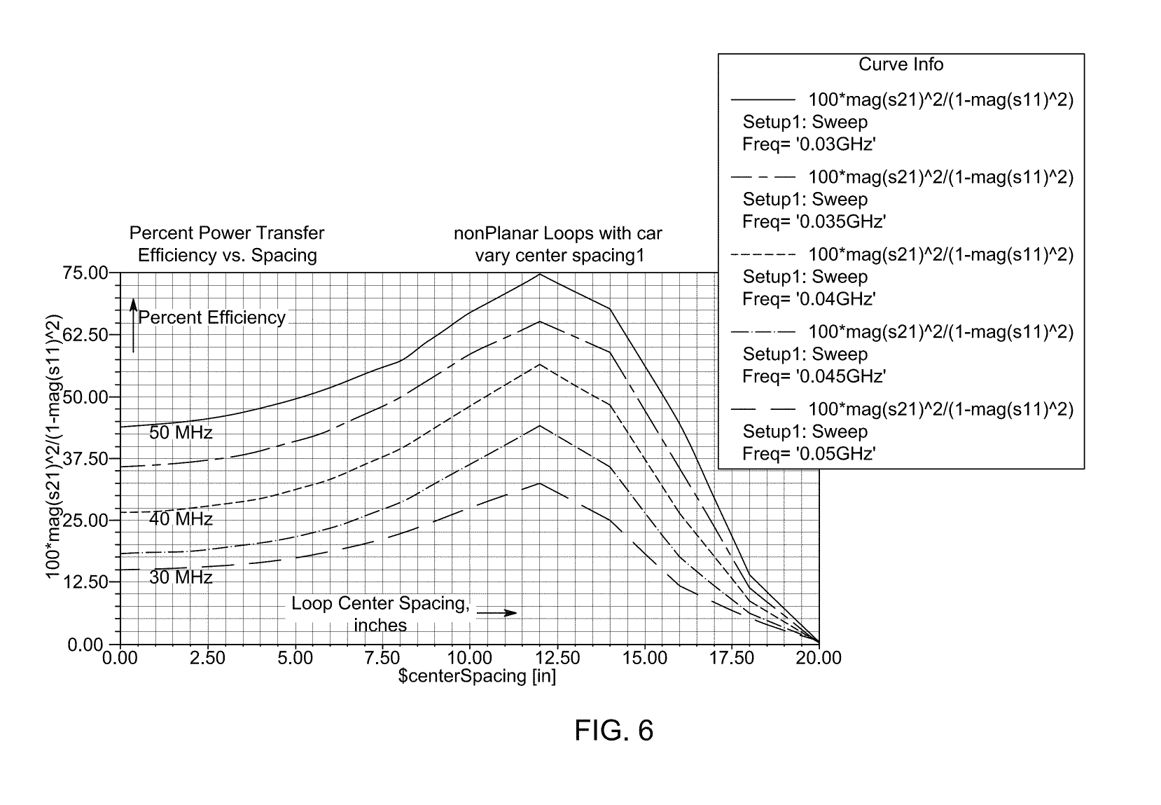

FIG. 6 is a plot generated from a computer model of a vehicle 100 and charging station 200. The plot shows expected power transfer efficiency versus loop position at different frequencies between 30 MHz and 60 MHz, with the wire loops 110, 210 in different horizontal planes. Efficiency peaks out at approximately 12″ center separation, when the loop conductors are closest, and higher frequency is better.

What is claimed is:

1. An apparatus for charging an electric vehicle comprising:
a first wire loop antenna, disposed within a the vehicle;
a second wire loop antenna, arranged to beneath the vehicle and to transmit energy wirelessly from a radio frequency energy source to the first antenna;
with a diameter of the first wire loop antenna at least three times a diameter of the second wire loop antenna; and
an automatic impedance adjustment circuit connected to at least one of the first or second wire loop antenna.

2. The apparatus of claim 1 wherein each of the first and second wire loop antennas are a single turn wire loop.

3. The apparatus of claim 1 wherein the adjustment circuit further comprises a Voltage Standing Wave Ratio (VSWR) detector and an output impedance adjustment circuit coupled to the second wire loop antenna.

4. The apparatus of claim 1 wherein the adjustment circuit further comprises a detector and a receive impedance adjustment circuit connected to the first wire loop antenna.

5. The apparatus of claim 1 wherein the first wire loop is three feet in diameter.

6. The apparatus of claim 5 wherein the second wire loop is between one-half and one foot in diameter.

7. The apparatus of claim 1 wherein the first wire loop is formed of a metallic pipe having a cross sectional dimension between one-quarter and one-half inch.

8. The apparatus of claim 1 wherein the radio frequency energy source operates between 30 and 60 MHz.

9. The apparatus of claim 1 wherein the second loop antenna and radio frequency energy source are packaged in a floor mat.

10. The apparatus of claim 1 wherein the first loop antenna is further coupled to ambient power scavenging circuits.

11. The apparatus of claim 1 wherein one or more dipole elements are disposed withing the first wireless loop.

12. The apparatus of claim 1 addtionally comprising:
a VSWR meter coupled to the second wireless loop;
a detector coupled to the output of the VSWR meter to detect variations in transmit power above a determined level; and
a controller, coupled to disable the radio frequency energy source in response to the detector.
